(19) United States
(12) Patent Application Publication
(10) Pub. No.: US 2003/0109988 A1
(43) Pub. Date: Jun. 12, 2003

(54) Three-dimensional GPS-assisted tracking device

(76) Inventors: Randolph K. Geissler, Hudson, WI (US); Peter Y. Zhou, Riverside, CA (US); Dexing Pang, Riverside, CA (US)

Correspondence Address: Steven B. Pokotilow, Esq., Stroock & Stroock & Lavan LLP, 180 Maiden Lane, New York, NY, 10038, US

(21) Appl. No.: 10/272,597

(22) Filed: Oct. 15, 2002

Related U.S. Application Data
(60) Provisional application No. 60/328,975, filed on Oct. 12, 2001.

(51) Int. Cl. G01S 1/00

(52) U.S. Cl. 701/213; 342/357.07

(57) ABSTRACT

The present invention generally relates to systems, methods and applications utilizing the convergence of any combination of the following three technologies: wireless positioning or localization technology, wireless communications technology and sensor technology. In particular, certain embodiments of the present invention relate to a system for tracking and locating a person, an animal or an object three-dimensionally having at least one remote localization and sensing device, each device having a processing unit for calculating location coordinates; an information storage device for storing directional, distance, physiological and identification data; at least one sensor for providing sensor data; an accelerometer for providing speed and distance data; a magnetic flux gate sensor for providing directional data; and a transceiver for communicating location and sensor data to an ASP. The present invention also relates to various applications and systems utilizing the capabilities of such a device.

### CROSS-REFERENCE TO RELATED APPLICATIONS

This application claims priority to U.S. Provisional Patent Application Serial No. 60/328,975, filed on Oct. 12, 2001, entitled 3-D TRACKING DEVICE, which is incorporated herein by reference.

### FIELD OF THE INVENTION

The present invention generally relates to a system and method for remotely monitoring, and more specifically, to a system and method for remotely monitoring a person, an animal or an object within a three-dimensional area.

### BACKGROUND OF THE INVENTION

Various systems for localizing and sensing animate and inanimate objects are known in the art. Such systems, however, are generally inflexible and inefficient. More specifically, existing systems suffer from being incapable of being efficiently utilized for multiple business application having different types of remote monitoring needs and devices. Such systems also lack the ability to track persons that have entered a building or other form of structure that effectively blocks tracking signals such as high frequency signals from global positioning system (GPS) satellites. Furthermore, many such systems are generally incapable of generating alert messages based on both simple and complex alert parameters. As such, there exists a need for an improved localization and sensing system having a flexible structure with the ability to track objects three-dimensionally.

### SUMMARY OF THE INVENTION

The present invention is generally directed towards a remote localization device comprising an accelerometer having an acceleration output; a magnetic flux gate sensor for providing directional data; and a processing unit for calculating location based on outputs of the accelerometer and the magnetic flux gate sensor. It is to be understood that the remote localization device may be modified for use in different applications. For example, the remote device may be modified for precise localization in three dimensions inside a building. In such an embodiment, the remote device need not (but may) include sensors. In one such embodiment, the remote device includes several additional components, including: (1) a three-axis accelerometer; (2) a three-axis magnetic flux gate sensor; (3) an AM receiver; and (4) a radio frequency (RF) directional antenna. The directional antenna is preferably sensitive only to direction and not distance and may be a physically rotating antenna or an electronically controlled antenna having a shifting phase. In addition, the system utilizes a reference station placed outside the building, for example, in front of the entry way to the building. The reference station preferably includes an RF transmitter and, optionally, a GPS receiver; the reference station can also be an existing one such as the Colorado atomic clock station.

In general, information obtained from the accelerometer, gate sensor, AM receiver and RF directional antenna is fed to the processing unit of the remote device and used to determine the wearer's location in the building. More specifically, the information is processed to obtain the three-dimensional location of the wearer (e.g., the floor that the wearer is on and the location of the wearer on that floor).

### BRIEF DESCRIPTION OF THE DRAWINGS

FIG. 1 is a general schematic overview of a wireless communications system utilizing a Three-Dimensional GPS-Assisted Tracking Device constructed according to one embodiment of the invention.

FIG. 2a is a schematic of a Three-Dimensional GPS-Assisted Tracking Device, according to one embodiment of the present invention.

FIG. 2b is a schematic of a Three-Dimensional GPS-Assisted Tracking Device, according to one embodiment of the present invention.

FIG. 3 is a schematic of a Reference Station according to one embodiment of the present invention.

FIG. 4 is a top view of a reference station in front of a building for illustrating the process of calculating the relative position of the Three-Dimensional GPS-Assisted Tracking Device according to one embodiment of the present invention.

FIG. 5 is a flow chart illustrating the process of calculating the relative position of the Three-Dimensional GPS-Assisted Tracking Device according to one embodiment of the present invention.

### DETAILED DESCRIPTION OF PREFERRED EMBODIMENTS

Although the present invention is generally applicable to systems and methods for remote monitoring, the following embodiments according to the present invention contemplate systems and methods for remotely monitoring a person, an animal or an object three-dimensionally.

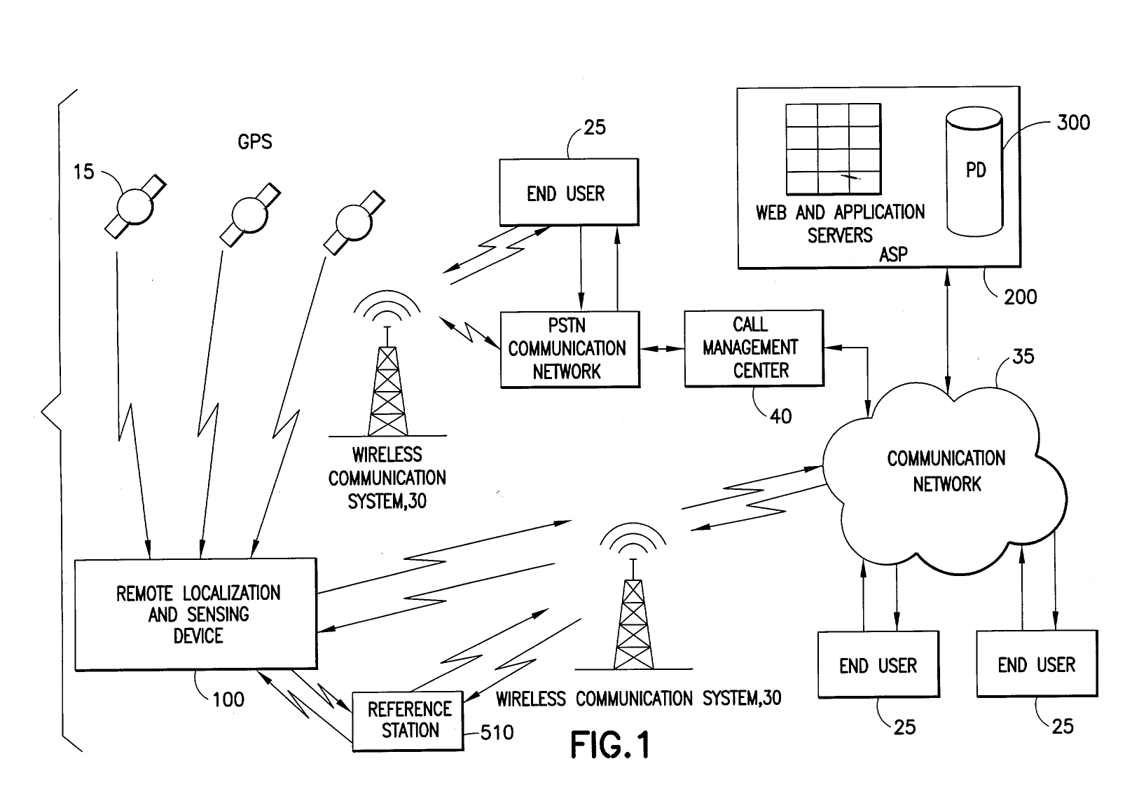

The schematic of FIG. 1 provides an overview of the components of one embodiment of the present invention and the components' relation to each other. In general, the system of the present embodiment collects position and sensor data via one or more remote localization and sensing devices (each a “Device”) 100, stores the device data at an Application Service Provider (“ASP”) 200 and, via the ASP 200, makes such Device position and sensor data available to one or more end users 25. As described in greater detail below, the present embodiment provides the flexibility to accommodate multiple users 25 across multiple applications. More specifically, the system can be used to service multiple business applications, each having different business rules and models and each utilizing Devices with different configurations, sensors and the like. Depending upon the application of the system, end users 25 may be individuals, for example, caregivers monitoring patients, parents monitoring children and the like, and/or companies, such as common carriers monitoring fleets of trucks, merchants monitoring shipments, government entities monitoring individuals, companies monitoring employees and the like. Furthermore, independent of the applications, the system can logically associate end users 25 with accounts and/or groups of users within an account, and the system can assign different access privileges to end users 25 based on such group and account assignment.

Each Device 100, described in greater detail below, receives position data from a localization system, such as the Global Positioning System (GPS) Satellites 15 and sensor data from one or more types of known sensors. As such, the Device 100 is coupled to or associated with the individual or object being monitored and tracked. It should be understood that, the present invention is not limited to any particular localization system or sensor. Accordingly, alternate embodiments utilizing other localization systems and technology, including, for example, triangulation, radio frequency triangulation, dead reckoning and the like, or any combination thereof are envisioned without departing from the spirit of the invention. Some such systems are described in pending International Application No. PCT/US01/48539, incorporated herein by reference. Similarly, sensors may include those for monitoring physiological parameters, such as heart rate, body temperature, brain activity, blood pressure, blood flow rate, muscular activity, respiratory rate, and the like, and/or sensors for monitoring ambient parameters, such as temperature, humidity, motion, speed, direction, existence of particular chemicals and light for example. Specialized sensors, such as inertial device-based fall detectors (for example, those utilizing one or more accelerometers) provided by Analog Devices under the trade name ADXL202, are also envisioned. Other exemplary sensors include pulse rate sensors from Sensor Net, Inc., under Model No. ALS-230 and temperature sensors (type NTC) from Sensor Scientific, Inc., under Model No. WM303 or Model No. SP43A. Pulse rate sensors are available from Sensor Net Inc., Model No. ALS-230; Infrared optical sensors are available from Probe Inc. As described in greater detail below, the Device 100 and/or ASP 200 monitor the sensor output and generate alert messages to the end users 25 if the sensor data exceeds an alarm threshold.

In general, each Device 100 communicates the position and sensor data to the ASP 200 through a wireless communications system 30. The systems can potentially utilize any number of commercially available wireless data communications solutions available from a number of different service providers. Some examples of the types of wireless data communications interfaces that may be used include: Cellular Digital Packet Data (CDPD), Global System for Mobile Communications (GSM) Digital, Code Division Multiple Access (CDMA), and digital data transmission protocols associated with any of the ‘G’ cellular telephone standards (e.g., 2.5G or 3G). In a preferred embodiment, the system uses CDPD as the communication technology and user datagram protocol (UDP) with Internet protocol (IP) as the transmission protocol, although other protocols may be used such as transmission control protocol (TCP). As such, and as described in greater detail below, the Device 100 is assigned a specific IP address. In the present embodiment, the wireless communication system 30 passes the data to a wired communication network 35, such as the Internet, with which the ASP 200 is in communication. As described below, the communication system 30 and communication network 35 provide for two-way communication between the Device 100 and ASP 200.

The position and sensor data is preferably stored at ASP 200, which serves as an intermediary between the Devices 100 and end users 25. As such, end users 25 are able to monitor the instantaneous and historical position and sensor data for one or more Devices 100. ASP 200, described in greater detail below, receives the position and sensor data from the communication system 35 and serves as a link between the device data and the end users 25 of the system. In general, ASP 200 comprises one or more servers (e.g., web server(s), application server(s), electronic mail server(s) and/or database server(s)) and one or more platform databases (PD) 300. ASP 200 can provide end users 25 the ability to access the device data, specify alert threshold values for comparison to measured sensor values and receive notifications from the ASP 200. For example, in the event a measured sensor value exceeds an alert threshold, the ASP 200 notifies the appropriate end user 25. End users 25 can receive such alerts through any number of alert devices (“Alert Devices”), such as a cellular telephone, telephone, pager, WAP enabled cellular telephones, Personal Digital Assistants (PDAs), computer or other devices having electronic mail, Short Message Service (SMS) messages, or Instant Messages (IM) capability, fax, computer generated voice phone calls/voicemail, or messages sent to a Call Management Center, which will generate a human phone call to alert the user 25, such as the caregiver of an Alzheimer patient or the parent of a child.

In the present embodiment, end users 25 access device data, specify alert thresholds, and access account information through a user device, such as a computer, WAP enabled cellular telephone, a PDA or other device including those identified as possible Alert Devices. In the present embodiment, the user interface device is a computer coupled to the Internet for accessing a secure website provided by ASP 200 on the communication network 35. The user interface device may be the Alert Device. End users 25 who do not have direct access to the communication network 35, can also access the device data and specify alert threshold values using conventional telephone communication networks to contact a central Call Management Center (CMC) 40 that is staffed with personnel that can access the ASP 200 via the communication network 35 or other networks, such as a wide area network (WAN), a local area network (LAN) or the like. The CMC 40 may also include a computerized, automated response system allowing end users 25 to call in and receive device data, alerts and other system information. The ASP 200 can forward a message to the CMC 40 whenever an alert, as described in greater detail below, is generated. This information can be used by personnel at the CMC 40 to respond to inquiries from end users 25 who may call the CMC 40 for additional information beyond the basic message generated by the ASP's automatic notification system. The personnel at the CMC 40 would also be available for users who have difficulty accessing or using the system Website, described in greater detail below, to configure the Device 100. The CMC 40 will also be charged with fielding phone calls from users responding to alerts. In addition, the CMC 40 will proactively call users to verify changes that have been suggested to their alert parameters that may generate a large number of spurious alerts. In an alternate embodiment, if users do not have access to the Internet or to a CMC 40, an automated telephone system hotline will be available to obtain real-time data after PIN verification.

The System may potentially implement a number of different security measures to safeguard the personal location and sensor data of users 25 and location of Devices 100, to prevent illicit commands from malicious third parties and to secure the data stream from potential interlopers. The data channel itself, since it may use standard UDP/IP or TCP/IP protocols, can be protected using a number of commercially available schemes including Secure Socket Layer (SSL) encryption for the data stream between the Device 100 and the ASP 200. The raw data itself may be further encrypted by the Device 100 and/or ASP 200 in addition to the SSL as well. Embedding additional encryption and device/server identification techniques into the ASP 200, Devices 100 and/or user interface devices can enable further protection.

In yet another embodiment, a reference station 510 is used to initialize the device 100 with initial positioning data, and to track the device 100 thereafter. The reference station 510 may be permanently installed in a predetermined location or may be mobile such as on a truck, a van, a fire engine and the like to track persons or objects within a structure. The reference station 510 may also be coupled to the communications system 30 to upload or download location and/or physiological data from the ASP 200 or the CMC 40 through the communication network 35 which may ultimately be made available to the end user 25.

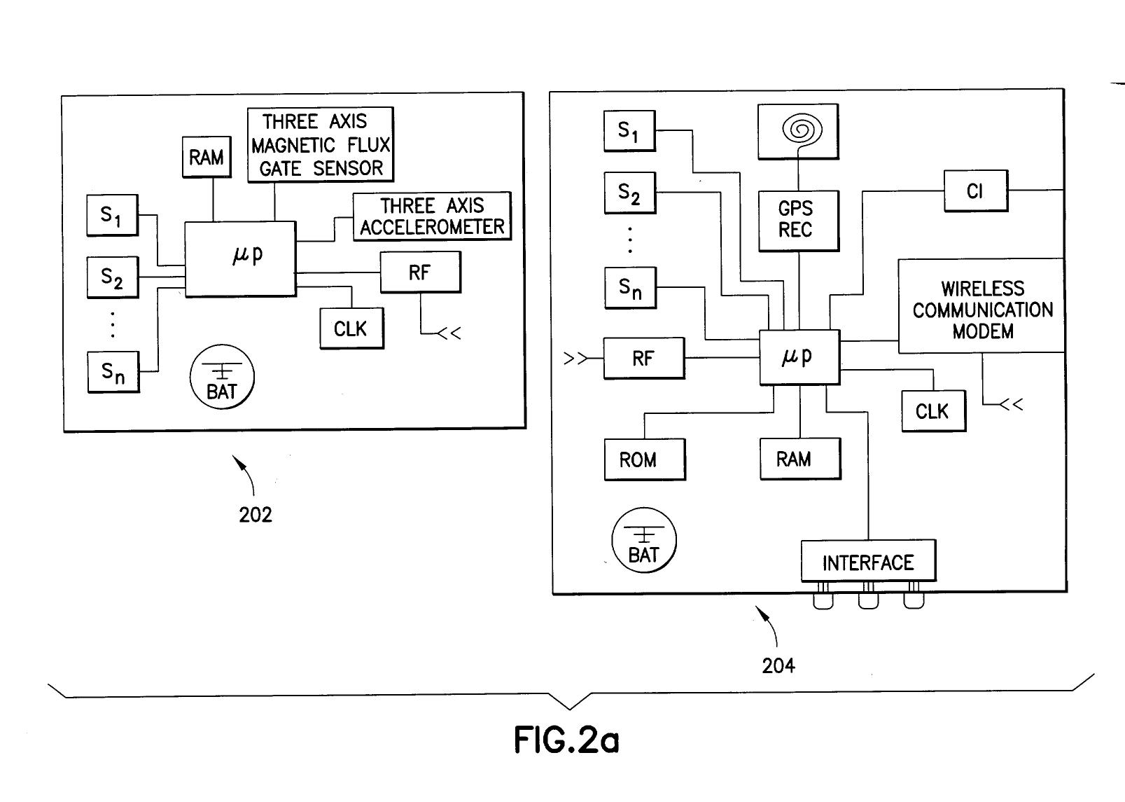

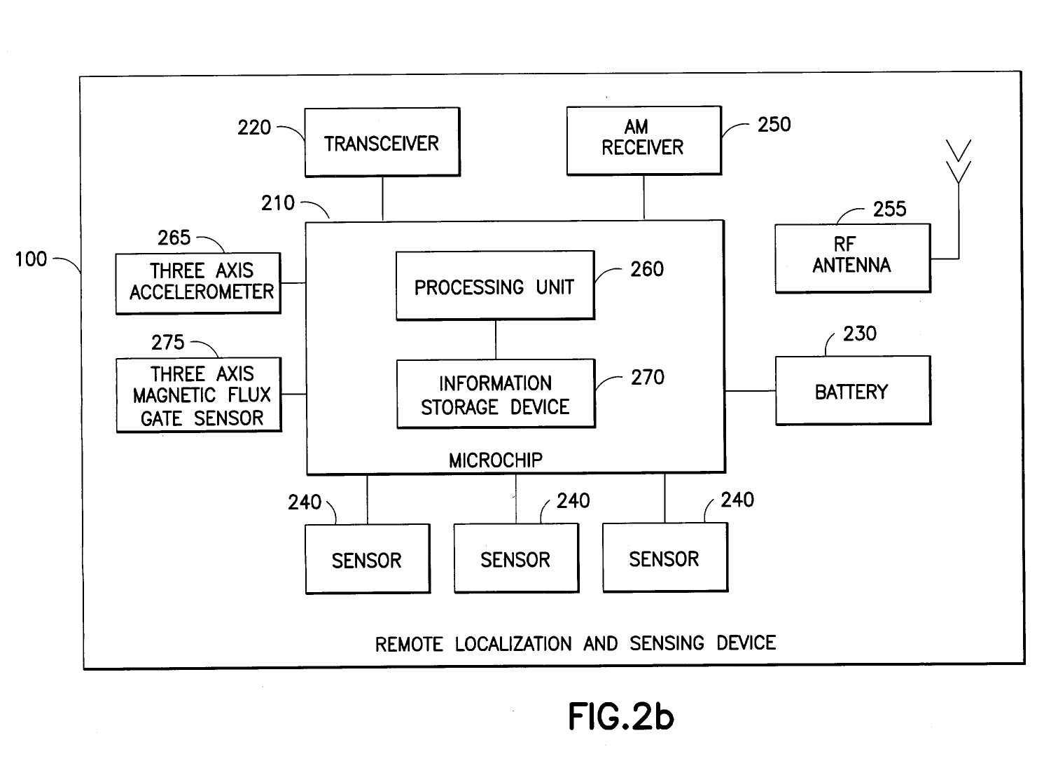

FIG. 2a illustrates components of the Device 100 according to one aspect of the invention. In general, the Device 100 of the present embodiment comprises two separate components: the first component 202, for example a watch unit, comprises, for example, at least one sensor for monitoring the person or thing being tracked, and the second component 204, for example, a “belt” communication unit (so called because it may be designed for an individual to wear on her belt), for communicating with the watch unit 202 via short-range radio frequency (RF), Blue Tooth or other known technology, and for communicating with the reference station 510 and/or ASP 200.

In a preferred embodiment, the watch unit 202 comprises a microprocessor (up), having a system clock (CLK), which is programmed to operate in accordance with the discussion herein: Coupled to the microprocessor are one or more sensors (S₁, S₂, Sₙ), for receiving physiological or ambient readings, random access memory (RAM) for temporarily storing the measured sensor readings, a three-axis magnetic flux gate sensor for measuring direction, a three-axis accelerometer for measuring speed and distance and a radio frequency transceiver (RF) and antenna for communicating with the belt unit 204. The watch unit 202 is powered by a battery (BAT).

In a preferred embodiment the belt unit 204 also comprises a microprocessor (up), having a clock (CLK), which is programmed to operate as described herein. Such programming may be stored in read only memory (ROM) coupled to the microprocessor. In alternate embodiments the functionality of the belt (and/or watch) unit 204 is effectuated in firmware. The belt unit 204 may also include one or more sensors (S₁, S₂, Sₙ) for collecting data. In the present embodiment, belt unit 204 may also include a directional sensor such a the three-axis magnetic flux gate sensor and a distance sensor such as the three-axis accelerometer, the outputs of which are interpreted by the belt unit's microprocessor. In general, the accelerometer output indicates a fall (or sudden change in posture) when based on the user's sudden change in acceleration and sudden deceleration or stop. The accelerometer is also used to track the distance that an object or person has traveled, and when used in concert with the three-axis magnetic flux gate sensor, positioning data can be ascertained within a structure.

As with the watch unit 202, the belt unit 204 also includes a random access memory (RAM) for temporary storage of data, including alert threshold values.

A GPS receiver (GPS REC), having a patch or other suitable antenna, is coupled to the microprocessor. The GPS REC receives the GPS satellite signals, which in a preferred embodiment are interpreted by the microprocessor to determine the longitudinal and latitudinal coordinates of the belt unit 204. In an alternative embodiment, the GPS satellite signals may be interpreted at the ASP level for determining the longitudinal and latitudinal coordinates of the belt unit 204.

Also coupled to the belt unit is a wearer interface (INTERFACE) for conveying information to and receiving inputs from the wearer or user of the Device 100. For example, in a preferred embodiment, the INTERFACE includes a power switch, a panic or emergency button and light emitting diodes (LEDS) and/or an audible alarm and/or vibrating alarm. As described in greater detail below, the panic button causes the sensor and GPS position data to be sent to the ASP 200. In an alternate embodiment, the Device 100 includes a privacy button which causes the microprocessor to deactivate one or more predefined sensors. The LEDs provide indication of the status of the device; for example, on/off, functioning properly, sensor(s) enabled/disabled, malfunction, and the like.

Lastly, in a preferred embodiment, the belt unit 204 includes a communication interface (CI), such as a serial port, for receiving updates of software and data, and a wireless communication modem (MODEM), having an antenna, for communicating with the ASP 200 via the UDP protocol. As discussed herein, the UDP MODEM has associated with it an IP address for identifying the Device 100.

As described in greater detail below, the watch unit 202 acquires the sensor readings and transmits them via RF to the belt unit 204 where the microprocessor analyzes the sensor readings (including that of any sensor on the belt unit 204). The microprocessor on the belt unit 204 also receives the GPS signals and determines the position data of the belt unit 204.

Based on the state of the Device 100 and the requests received from the ASP 200, the belt unit 204 will determine whether or not the sensor readings trigger an alarm and/or read the position and sensor data back to the ASP 200 via the modem.

In one embodiment, the belt unit and/or the watch unit processor monitors the separation distance between the “watch” and “belt” units by monitoring the total power of the RF transmission signal from the “watch” to the “belt” unit. When the total power of the signal drops below a pre-set value, the belt unit will then trigger an alert to both the Device 100 (e.g., visual, audible or tactile) and to an Alert Device via the ASP 200 to notify the wearer or others of the separation of the two units. The mounting of the watch unit 210 to the wearer must be snug enough to obtain useful physiological data and durable enough not to be easily removed, while still being comfortable enough for long-term use. An embodiment of the invention contemplates the use of a semi-permanent, elastic band for the watch unit.

It should be understood that use of the foregoing terms “watch” and “belt” are descriptive of merely one embodiment or use of the Device of FIG. 2a. For example, the watch unit may be placed inside a container of goods with a radio frequency or other wireless or wired communication link to the belt unit, which may be mounted in any suitable location, such as in the cab of a truck transporting the container. Furthermore, the specific sub-components of the Device 100 of FIG. 2a are merely exemplary, and the division of sub-components and functionality between the watch and belt units may be altered; for example, all sensors may be placed on one component, the GPS receiver may be placed on the watch unit, the watch unit microprocessor could analyze the sensor data to determine whether or not an alert threshold has been exceeded, the watch unit may have the wearer/user interface, and various other modifications are within the scope of the present invention.

In this regard and with continued reference to FIG. 1, FIG. 2b illustrates an alternate embodiment of the invention wherein the Device is a single component comprising a microchip 210, a transceiver 220, an AM receiver 250, a battery 230, a three-axis accelerometer 265, a three-axis magnetic flux gate sensor 275, an RF antenna 255 and at least one sensor 240.

The microchip 210 includes a processing unit 260 and an information storage device 270. Although FIG. 2a illustrates some parts included on the microchip 210 and some parts coupled to the microchip 210, one of ordinary skill in the art understands, and the present invention contemplates, that different levels of integration may be achieved by integrating any of the coupled parts as illustrated in FIG. 2b onto the microchip 210.

In an embodiment according to the present invention, the battery 230, the sensor 240, the transceiver 220, the three-axis accelerometer 265, the three-axis magnetic flux gate sensor 275, the RF antenna 255 and the AM receiver 250 are each coupled to the processing unit 260 within the microchip 210. The processing unit 260 is, in turn, coupled to the information storage device 270, also within the microchip 210. The battery 230 powers the microchip 210, including the processing unit 260 and the information storage device 270. The battery 230 may also power directly or indirectly the transceiver 220, the at least one sensor 240 and the AM receiver 250. The battery 230 may be a rechargeable (e.g., self-rechargeable) or a single-charge power supply device.

Where a self-rechargeable battery is used, the battery 230 may be recharged by energy sources internal to a body of the person being monitored. Such energy sources may be, for example, acoustic, mechanical, chemical, electrical, electromagnetic or thermal in nature as derived from, for example, bodily temperature differences, muscle activity and vibrations due to pulse, speaking, moving, breathing, etc. In other embodiments where the battery is self-rechargeable, the battery 230 is recharged by energy sources external to the body of the person being monitored. Such energy sources may be, for example, acoustic, mechanical, chemical, electrical, electromagnetic, or thermal in nature as derived from, for example, temperature differences between the ambient and the body, vibrations due to ambient noise, ambient light, or an external device providing energy for the rechargeable battery 230.

In the present embodiment of the invention, the transceiver 220 is adapted to be in two-way wireless communication with the ASP 200 through the communication network 35, such as the Internet, and in one-way wireless communication with the GPS satellite 130. The transceiver 220 may have a single antenna or an antenna array, for example.

While the transceiver 220 is in two-way wireless communication with the ASP 200 through the communication network 35, the AM receiver 250 is in one-way wireless communication with the GPS system satellite 130. The use of the transceiver 220 and the AM receiver 250 may be advantageous in that the Device 100 may generally consume less energy. GPS frequencies tend to be relatively high and sending information over such frequencies by the Device 100 via the transceiver 220 can be energy intensive. This preferred embodiment contemplates the receiver 250 being adapted for receiving at high frequencies and the transceiver 220 being adapted for receiving and sending at lower frequencies. The sending of information over lower frequencies by the transceiver 220 results in less energy consumption by the Device 100. This two-part configuration allows physical environment sensor packages to be reduced in size and mounted in otherwise GPS signal or mobile wireless data transmission unfriendly environments. For example, a remote sensing unit can be placed inside the steel walls of a cargo container to gather environmental information on the cargo while the unit with the wireless interface and the GPS receiver 530 can be placed outside the container for superior signal performance. An alternate embodiment of the invention omits a separate receiver and contains only a transceiver that receives both sensor data from the at least one sensor 240 and/or position data from the GPS satellites 130. In another alternate embodiment, the RF antenna 255 transmits three-dimensional positioning data to the reference station 510 which is, in turn, transmitted to the ASP 200 through the communication network 35.

The microchip 210 includes the processing unit 260 and the information storage device 270. The processing unit 260 may include, for example, a microprocessor, a cache, input terminals, and output terminals. The processing unit 260 may include an information storage device 270, which includes an electronic memory, which may or may not include the cache of the processing unit 260. Similar configurations of the processing unit 260 are contemplated by the invention.

In operation, the AM receiver 250 receives position data from the GPS satellites 130 or from the reference station 510. The position data is received by the microchip 210 and in particular, the processing unit 260. Although the AM receiver 250 continuously receives position data, the processing unit 260 may periodically (e.g., via a time-based trigger), or on command (e.g., via manual intervention or as a function of circumstance, for example, the sensing of a particular biological or ambient condition) receive the position data. The position data may then be processed in the processing unit 260, which may include determining the physical location of the Device 100 and thus, the person or object being monitored. The position data and/or the determined physical location are stored in the information storage device 270.

In operation, the accelerometer 265 is used to provide the local distance traveled by the wearer and one orientation information relative to the gravity. More specifically, the accelerometer 265 provides acceleration data which, when integrated based on time, results in a speed, and a relative distance measurement. The time factor used with respect to the accelerometer data is obtained from a local clock signal, preferably with the help of the AM receiver 250, which receives precise time information. Such time information may be that of an atomic clock including the Colorado atomic clock station, GPS or other devices. The local clock may be periodically calibrated by the atomic clock signal because the atomic clock signal is more accurate than most crystal oscillators that are used in portable devices and another benefit is that the error caused by the atomic clock does not accumulate.

The magnetic flux gate sensor 275 is generally used to determine relative direction of movement of the wearer. As is known, such a gate sensor responds to changes in magnetic flux associated with the orientation. Thus, the processing unit of the remote device is able to calculate direction and distance base on the output of the accelerometer 265 and gate sensor 275. The directional information provided by the flux gate sensor 275, however, may be subject to environmental factors and, therefore, may include errors. Therefore, the present embodiment utilizes a second order directional reference.

Such a second order directional reference is provided in the form of the RF directional antenna 255 and transmitter. The directional antenna 255 may be a micro-array antenna or a micro-strip antenna. More specifically, the highly directional RF antenna 255 receives the beacon signal transmitted from the reference station 510 placed outside the building. As the wearer deviates from the initial heading, the calibrated strength of the signal received from the directional antenna weakens. In other words, the calibrated signal strength is indicative of the wearer's direction. The device 100 correlates the signal strength into direction. Furthermore, with the reference station's 510 location pinpointed with the use of GPS, the RF transmitter may be used as a carrier signal for the location of the reference station 510 and transmitted to the device 100. The processing unit of the device 100, in turn, utilizes the GPS location of the reference station 510 as a positioning reference.

It should be appreciated that the present embodiment minimizes the local error of the device 100 by utilizing three external reference points. The first reference point is the accurate time reference provided via the AM receiver 250. The second reference is the directional reference provided by the directional RF antenna 255. The third reference is the position reference provided by the GPS-derived location of the reference station 510.

It should also be understood that the present embodiment provides for accurate triangulation of the wearer's location. In general, use of the accelerometer 265 and flux gate sensor 275 provide an initial position reading. As noted above, such initial position reading may contain errors. Therefore, the creation of an additional reference point may be used to reduce the error. More specifically, a second position reading may be obtained based on the time delay between the time reading received via the AM receiver 250 and the time reading contained within the GPS signals. For example, the time twelve noon may be received via the AM receiver 250 at one instant and the time of twelve noon may be received via the GPS satellite time at another instant; knowing the speed and frequency of each time signal, and the distance between these reference stations, the distance between the wearer and the reference point may be determined. Such distance may be used to reduce the error in the position reader of the wearer.

The sensor 240 senses biological and/or ambient parameters. These parameters are converted into electrical signals by the sensor 240 and received by the processing unit 260. As described in detail below, the sensing of parameters by the sensor 240 may be a periodic (e.g., time based) or on command (e.g., triggered by a request from the processing unit 260 or as a function of circumstance, for example, the sensing of a particular parameter). The processing unit 260 stores the processed and/or unprocessed electrical signals in the information storage device 270. The transceiver 220 receives the interrogation signal, for example, from the ASP 200. The transceiver 220 then sends the interrogation signal to the microchip 210, in particular, to the processing unit 260. Upon receiving the interrogation signal, the processing unit 260 uploads the information stored in the information storage device 270 onto the transceiver 220. The transceiver then sends the uploaded information to the ASP 200 via the communication network 35, such as the Internet, and the wireless communication system 30.

As mentioned above, the ASP 200 ultimately receives the information where it is available for review by a qualified person or analyzed via an automated process. If the information is indicative of a condition in need of a response, a response signal is sent by the qualified person or via the automated process from the ASP 200 to the Device 100 via the communication network 35 such as the Internet. The processing unit 260 receives the response signal either via the transceiver 220 or the AM receiver 250. The processing unit 260 processes the response signal and optionally, information retrieved from the information storage device 270 to formulate a control signal. Information regarding the generation of the control signal may be a function of information supplied by at least one of the response signal and the information storage device 270.

For example, the system and the method according to the present invention may be adapted to monitor and to respond to the person suffering an asthma attack. The Device 100 monitors biological parameters such as blood pressure, heart rate, respiratory rate and/or lung capacity. Information related to the biological parameters is sent to the ASP 200 as described above.

The information storage device 270 may store preset information relating to identification, personal information or special medical information, for example. This information may have been programmed before the coupling of the Device 100 to the person. Alternatively, the information may have been transmitted to the Device 100 after the Device 100 was coupled to the person. Such information may include the person's name, home address, phone number and/or a listing of relatives to contact in case of emergency. Furthermore, the information permanently stored in the Device 100 may relate to special medical information such as allergies to medication or that the patient is diabetic or asthmatic, for example. All of this information may be uploaded onto the transceiver 220 and transmitted to the ASP 200 for review and analysis. Such information may be of special significance to medical personnel when the person is disoriented or unconscious and unable to communicate.

Incorporating updateable firmware in the Device 100 allows it to be updated without a recall of the physical Device 100. The Device 100 may be configured for direct user update by plugging it into a computer and running an update program provided. In an alternate embodiment, the Device 100 may be updated by downloading firmware updates through a wireless link. This would allow multiple Devices 100 to be updated at essentially the same time, thereby minimizing support issues and reducing required customer maintenance.

In yet another alternate embodiment, the Device 100 further includes a component for providing various forms of feedback or stimuli to a person, animal or object via an output unit. Output units can take any form to achieve the intended function. By way of non-limiting example, output units may take the form of syringes, electrodes, pumps, vials, injectors, drug and/or pharmaceutical or medicinal delivery mechanisms or systems, tactile stimulators, etc. Such an output unit may be integral with the Device or a separate component in communication with the ASP 200 and/or Device 100 by either wireless or wired communication link as a matter of application specific design choice.

In one such embodiment, such an output unit, which itself includes a microprocessor or logic for interpreting commands, may be coupled to the microprocessor of the device shown in FIG. 2b. In such an embodiment, Device 100 may be adapted to respond to a condition of the person (or animal, etc.) via an output unit. The Device 100 controls the output unit such that the output unit provides stimuli (e.g., acoustic, thermal, mechanical, chemical, electrical and/or electromagnetic stimuli) to the person. For example, the output unit may release an appropriate amount of medicine or provide electrical stimulation to a muscle. In another example, the output unit may be part of a conventional heart stimulator system that has been adapted to be controlled by the Device 100 and to provide electrical stimulation to the heart of the person 100.

Alternatively, in an embodiment according to the present invention in which the output unit is partially or wholly integrated into the Device 100, it is the Device 100 which provides the stimuli via the output unit which acts as an interface between the Device 100 and the person. For example, the Device 100 may be directly coupled to the heart of the person 100. Accordingly, the Device 100 may directly provide electrical stimulation to the heart via its interface (e.g., via the output unit).

In light of the information received by the ASP 200, an automatic, semi-automatic or manual response may be needed. For example, upon reviewing the information received by the ASP 200, a doctor may diagnose a condition and/or a substantial deviation in a biological parameter of the person and authorize the activation of a medical response. Alternatively, after analyzing the information received by the ASP 200, a program being run by the ASP 200 may ascertain a particular condition (e.g., myocardial infarction) and/or an above-threshold deviation in a biological parameter (e.g., substantial restriction in blood flow) of the person and authorize the activation of a medical response (e.g., the release of nitroglycerin into the body of the person). Then, a response signal is generated by the ASP 200 and provided to the Device 100 via the ASP 200. In response to the response signal, the Device 100 controls the output unit to provide the stimulus requested via the response signal to the person. Alternatively, if the output unit is partially or wholly integrated into the Device 100, the Device 100 directly provides the stimulus requested via the response signal to the person.

The output unit is adapted to be controlled by the Device 100 and, in particular, the processing unit 260. The output unit may also be partially or wholly integrated with the Device 100. For example, the output unit may be integrated wholly with the Device 100 and coupled to the microchip 210. Alternatively, the output unit may be integrated wholly with the Device 100 and may be integrated wholly with the microchip 210.

The output unit is further adapted to be provide stimuli (e.g., acoustic, thermal, mechanical., chemical, electrical and/or electromagnetic stimuli). For example, the output unit may be in contact with a muscle or an organ. Furthermore, the output unit may be an adapted conventional device such as a pace maker or a module that releases chemicals (e.g., medication) into the blood stream or into the stomach, for example. The present invention also contemplates that the output unit may provide sensor information to the Device 100. In addition, the output unit may be placed on the person, on the surface of the skin of the person, just below the surface of the skin of the person, deep within the body of the person, or anywhere therebetween. For example, the output unit may be adapted to be a part of an artificial body part of the person or an apparatus worn by the person (e.g., clothing, eye glasses, etc.)

The Device 100 controls the output unit via the control signal, the output unit providing the appropriate stimuli. For example, the system and the method according to the present invention may be adapted to monitor and to respond to the person suffering an asthma attack. The Device 100 monitors biological parameters such as blood pressure, heart rate, respiratory rate and/or lung capacity. Information related to the biological parameters is sent to the ASP 200 as described above. If qualified medical personnel and/or an automated process determines that a patient is having a serious asthma attack, a response signal can be sent to the Device 100 to remedy the condition. Upon receiving the response signal, the processing unit 260 controls the output unit to release a drug (e.g., adrenaline) into the blood stream of the person. Information relating to the amount, duration and/or frequency of the dosage may contained in the response signal, the processing unit 260 and/or the information storage device 270. Furthermore, control unit 140 can send subsequent response signals corresponding to different doses of the drug, for example, depending upon the improving or deteriorating condition of the person.

In another embodiment according to the present invention, the microchip is activated only when the transceiver 220 receives the interrogation signal and/or the response signal from the ASP 200. This embodiment has an advantage in that energy consumption is minimized. Upon receiving the interrogation signal, the processing unit 260 accepts data from the receiver 250 and the at least one sensor 240. The processing unit 260 may accept the data over a time interval to achieve more stable data or to develop a history of data. Such data may be processed and/or stored in the information storage device 270. Upon completion of the processing and/or storing of the data, the information contained in the information storage device is uploaded onto the transceiver 220 and transmitted to the ASP 200. After completing the transmission of the uploaded data via the transceiver 220, the processing unit 260 is no longer active in receiving, processing and/or storing information until the next interrogation signal or the response signal is received from the ASP 200. Upon receiving the response signal, for example, the Device 100 and the output unit act as described above. After completing the action, the processing unit 260 is no longer active in controlling the output unit or in receiving, processing and/or storing information until the next interrogation signal or the next response signal is received from the ASP 200. The present invention also contemplates the Device 100 and/or the output unit being activated via a manual switch or programmed button actuated by the person. It should be noted that the storage of data may occur at the information storage device 270, the reference station 510, the ASP 200 or any combination thereof.

As alluded to above, the information storage device 270 may store information relating to different types of stimuli provided by the output unit as well as stimuli parameters such as frequency, amount and/or duration. The information storage device 270 may also store preset information relating to identification, personal information or special medical information, for example. This information may have been programmed before the coupling of the portable device 100 to the person. Alternatively, the information may have been transmitted to the portable device 100 after the Device 100 was coupled to the person. Such information may include the person's name, home address, phone number and/or a listing of relatives to contact in case of emergency. Furthermore, the information permanently stored in the Device 100 may relate to special medical information such as allergies to medication or that the patient is diabetic or asthmatic, for example. All of this information may be uploaded onto the transceiver 220 and transmitted to the ASP 200 for review and analysis. Such information may be of special significance to medical personnel when the person is disoriented or unconscious and unable to communicate.

As will be described herein, various embodiments of the present invention employ power-saving features to prolong the life of the Device's battery. In this regard, in certain embodiments the Device 100 is capable of being turned on (from a low-power wait state) or off (into either a low-power state or completely off) remotely. Such function is controlled by messages received from the ASP 200 and, more specifically, by the microprocessor(s) of the Device. This allows the ASP 200 to remotely power individual Devices 100 up or down on-demand as necessitated by either business requirements or user request. In addition, the ASP 200 can remotely turn individual sensors in the Device 100 on or off (i.e., enable/disable) to provide enhanced monitoring corresponding to higher service levels, or to conserve power on the Device 100. Both of these features re-effectuated, in part, by particular messages and message protocols.

In the alternate embodiment of FIG. 2b, the microchip 210 is activated only when the transceiver 220 receives the interrogation signal and/or the response signal from the ASP 200. This embodiment has an advantage in that energy consumption is minimized. Upon receiving the interrogation signal, the processing unit 260 accepts data from the GPS receiver 250 and the at least one sensor 240. The processing unit 260 may accept the data over a time interval to achieve more stable data or to develop a history of data. Such data may be processed and/or stored in the information storage device 270. Upon completion of the processing and/or storing of the data, the information contained in the information storage device 270 is uploaded onto the transceiver 220 and transmitted to the ASP 200. After completing the transmission of the uploaded data via the transceiver 220, the processing unit 260 is no longer active in receiving, processing and/or storing information until the next interrogation signal or the next response signal is received from the ASP 200. Upon receiving the response signal, for example, the Device 100 acts as described above. The present invention also contemplates the Device 100 being activated via a manual switch or programmed button actuated by the person.

In another embodiment according to the present invention, the transceiver 220, without the AM receiver 250, is adapted to receive the GPS data from the satellite 130 and the interrogation signal and/or the response signal from the ASP 200. Furthermore, the transceiver 220 transmits information from the processing unit 260 to the ASP 200. Operation is similar as described above.

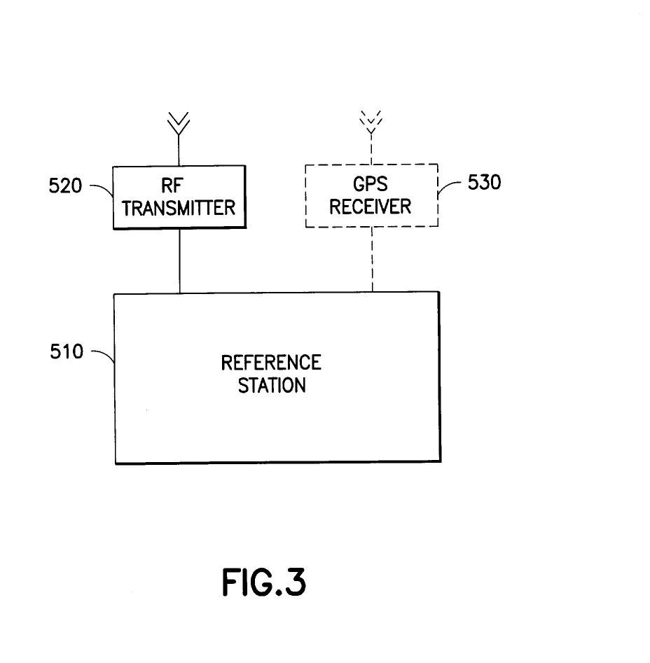

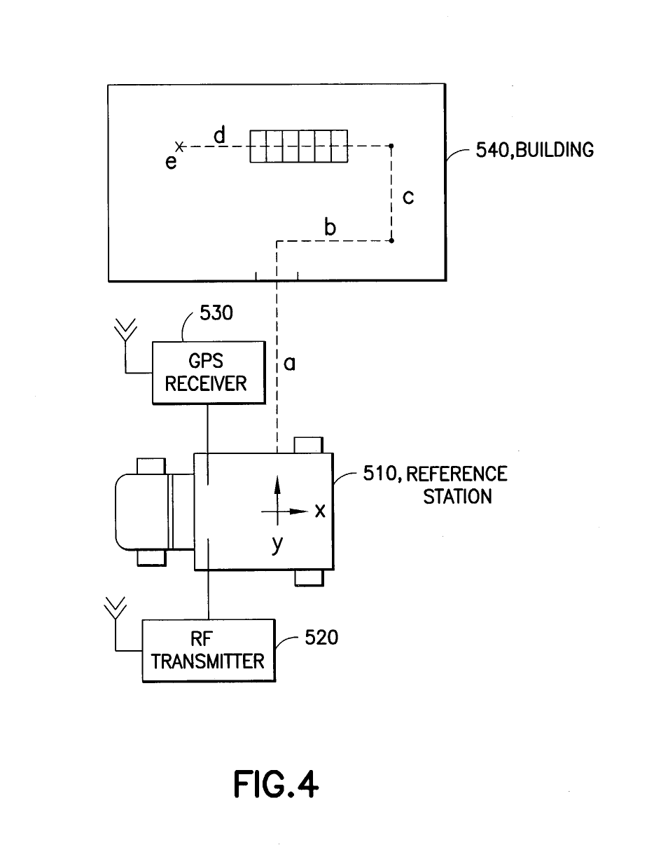

With reference now to FIGS. 3 and 4 and continued reference to FIGS. 1-2b, the reference station 510 is depicted with an RF transmitter 520 and an optional GPS receiver 530. As stated previously, the reference station 510 may be a fixed location, or may be a mobile unit. The reference station 510 is, in essence, an initialization point for the device 100 wherein the device 100 and the reference station 510 synchronize a starting point for the tracking of device 100. The RF transmitter 520 facilitates the transmission of data between the reference station 510 and the device 100 with the use of radio frequency signals. Radio frequency signals are used in this instance due to their ability to transmit through dense structures such as buildings. The device 100 is also capable of receiving high frequency GPS signals, however, the high frequency signals are not always capable of penetrating a high density structure such as a building.

The reference station 510 may also be equipped with a GPS receiver 530 which would receive global positioning coordinates from GPS satellites 15, as an additional mode of tracking device 100. As stated earlier, high frequency GPS signals may not always penetrate a high density structure such as a building, however, the reference station 510 may receive the GPS coordinates through the GPS receiver 530 and in turn transmit the GPS coordinates to the device 100 with the use of the RF transmitter 520.

In a preferred embodiment, the reference station 510 is incorporated within a mobile vehicle, as shown in FIG. 4. The mobile vehicle could be a truck, a van, or a fire engine wherein it is used to track the location of firemen within a building structure. In FIG. 4, the reference station 510 is shown as a truck having a GPS receiver 530 and an RF transmitter 520. As an example, the reference station 510 may be a fire truck. A fireman would exit the reference station 510 which is depicted as the truck and his initial position at the truck would be recorded as the starting point. The firemen would then enter the building through an entrance, and along the path designated as “a” with his speed, distance and direction being measured by the accelerometer 265 and the magnetic flux gate sensor 275 which are incorporated into the device 100. The firemen may then turn within the building, walk down a hallway which is denoted as path “b”, then turn down another hallway indicated by path “c” and finally may travel up a staircase, an escalator, an elevator or the like and along the path indicated as “d” ultimately ending at point “e”. The processing unit 260 would then calculate the exact location of the firemen based on the direction and distance measured with the use of the data from the accelerometer 265 and the data from the magnetic flux gate sensor 275. This would allow the reference station 510 to calculate and determine the exact location of the firemen within the building. The reference station 510 may then use this information to retrieve the fireman, or may transmit this data via the communication system 30 to the ASP 200 for access by the end users 25. It should further be noted that the calculation of data may occur in the device 100, in the reference station 510, in the ASP 200 or in any combination thereof.

The data from the device 100 will be stored internally, as previously stated, on the information storage device 270 for transmission to the reference station 510 either periodically, aperiodically or by manual intervention.

With continued reference to FIGS. 1-4, a privacy mode may be incorporated in the Device 100 that will allow it to temporarily stop reporting information. Privacy mode may take a number of different forms. It may place the unit into a deep sleep mode where the system is completely unable to respond to any requests for data and does not collect any data. Alternatively, the privacy mode may simply suppress the collection of particular type of data (such as location information) while still keeping the system up and running to provide a baseline level of information. The system will respond to requests from the ASP 200 with either a notice that the system is operational and not responding with data due to a privacy mode block, or only respond with a limited set of information. Privacy mode would generate a flag in the PD 300, described in greater detail below, to prevent further polling of the Device 100 by the ASP 200 and a false alarm that the unit is not functioning properly. In addition, the Device 100 can be recalibrated from the ASP 200 during normal operation via the wireless data link to enable rescaling of sensor gains or sensor offset.

The Device 100 may also have a system sleep mode, which reduces power consumption between data collection and transmission intervals. To conserve power, the Device 100 will only power-up the wireless data line transceiver 220 to determine if a message is waiting for it. If there is no message, the Device 100 will power down until the next prescheduled check time. If a message is waiting, the Device 100 will begin “waking up” specific components needed to respond to the message. In addition to this scheme, the GPS receiver 250 can also self-power down when it does not receive a usable set of satellite signals. Both of these sleep modes save Device 100 power and extend battery life.

The Device 100, and more particularly the device microprocessor(s), can preferably conduct both startup testing and continuous system checking during operation for self-monitoring. Information such as low-battery warnings, sensor malfunctions, no GPS signal and the like may be detected by a Device microprocessor and communicated to the ASP 200.

It should be understood that in alternate embodiments, different reference timing and directional signals may be used. Furthermore, the reference timing and directional signals may be acquired via the same or different reference systems and may be acquired by the same or different antenna and receivers.

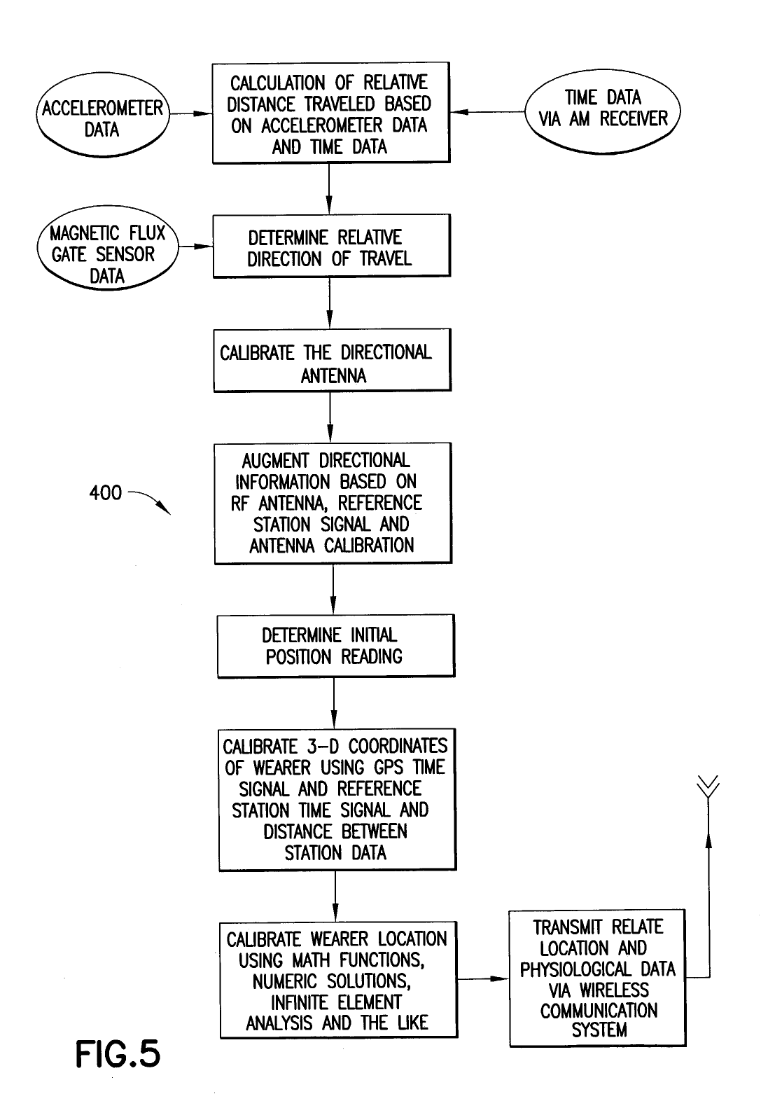

Referring now to FIG. 5, the following steps summarize the operation (i.e., programming) of the processing unit 260 of the device 100 according to the present embodiment:

1. calculate relative distance traveled based on accelerometer data and time data as received from the local clock signal and the reference station via AM receiver;

2. determine relative direction of travel based on magnetic flux gate sensor;

3. calibrate the directional antenna based on known antenna dynamic characteristics;

4. augment directional information based on directional RF antenna and reference beacon signal, and the antenna calibration information;

5. determine initial position reading based on the foregoing steps;

6. use the difference between the GPS time signal and reference station time signals, the known distance data between these stations to calibrate the measured three-dimensional coordinates of the wearer; and

7. use additional math functions, such as numeric solutions, infinite element analysis and the like, as a further aid to calculate the wearer's location.

Exemplary component specifications and system design specifications are as follows:

Geo-magnetic sensor: Compact size<10 mm×10 mm×10 mm, SOC design, high sensitivity (10 mV/mT), 0.25 degree resolution on up to 360 degree Azimuth scale;

Gyro-3D accelerometer: Compact size<10 mm×10 mm×10 mm, SOC design, high resolution (2 mg at 60 Hz), measures both dynamic and static acceleration;

DSP: high performance 32-bit floating-point digital signal processor such as TMS320VC3X family;

Operation temperature: −55° C. to +125° C., alignment error: 0.01 degree, cross-axis sensitivity: 2%.

An exemplary system may be designed as follows:

Local reference station: Preferably movable and can be stand-alone device close to the operating unit, compact design, optional to the operation if another timing station such as atomic station is used, useful if a reference direction base is required to aid the compass for high accuracy;

Battery operated: The whole system (remote device and reference station(s)) is preferably powered by a rechargeable battery.

Portable compact design: 3″×2″×1″

Local network: A wireless monitoring device is required to communicate with the terminal devices via RF link, if the wide area communication is required, additional wireless modem such as CDMA, two-way pager or CDPD or radio modem will be integrated into the device.

In the foregoing description, the method and the system of the present invention have been described with reference to specific embodiments. It is to be understood and expected that variations in the principles of the method and the system herein disclosed may be made by one of ordinary skill in the art and it is intended that such modifications, changes and substitutions are to be included within the scope of the present invention as set forth in the appended claims. The specification and the drawings are accordingly to be regarded in an illustrative, rather than in a restrictive sense.

What is claimed is:

1. A localization system comprising:
an accelerometer having an acceleration output;
a magnetic flux gate sensor having a first directional output; and
one or more processing units coupled to the accelerometer and magnetic flux sensor to calculate a location based on the acceleration output and the first directional output.

2. The localization system of claim 1, wherein the processors are programmed to calculate distance traveled based on the acceleration output and direction based on the first directional output.

3. The localization system of claim 2, further comprising a directional antenna having a second directional output, the processors further programmed to calculate direction based on the second directional output.

4. A localization system as in claim 2, further comprising a receiver for receiving a time signal, the processors further configured to calculate distance traveled based on the time signal.

5. A localization system as in claim 1, further comprising a reference station, the reference station including a GPS receiver and antenna for determining an initial location and direction of travel.

6. A localization system as in claim 1, further comprising a reference station, the processing units programmed to calculate location relative to the reference station.

7. A localization system as in claim 1, wherein the system includes a remote localization device, the device including the accelerometer and the magnetic flux gate sensor.

8. A localization system as in claim 7, wherein the system further includes a bases station remote from the device, the base station including the processing units.

9. A localization system as in claim 7, wherein the device further includes the processing units.

10. A localization system as in claim 1, further comprising memory for storing outputs.

11. A localization system as in claim 1, wherein the processing units are configured to calculate path of movement, the system further comprising memory for storing the path of movement.

12. A localization system as in claim 1, further comprising memory for storing location.

13. A localization system as in claim 1, wherein the accelerometer is a three-axis accelerometer and the magnetic flux gate sensor is a three-axis magnetic flux gate sensor, the processing unit programmed to calculate location in three dimensions.

14. A localization system as in claim 1, wherein the system includes three accelerometers, each having an acceleration output in an orthogonal plane, the processing units programmed to calculate location in three dimensions.

15. A method of tracking a person, an animal or an object three-dimensionally comprising the steps of:
receiving acceleration data;
receiving time data;
receiving direction data relative to a reference;
calculating location based on the acceleration data, time data, direction data and the reference.

16. The method of claim 15, wherein the reference includes a direction.

17. The method of claim 15, wherein the calculating includes determining distance traveled based on the acceleration and time data, and direction based on direction data.

18. The method of claim 15, wherein acceleration data is received from one or more accelerometers and the direction data is received from one or more magnetic flux gate sensors.

19. The method of claim 15, further comprising transmitting the data to a base station for calculating the location.

20. The method of claim 15, wherein the calculating is performed at an object being localized.
